(19) United States
(12) Patent Application Publication
(10) Pub. No.: US 2015/0344116 A1
(43) Pub. Date: Dec. 3, 2015

(54) Stable elevated lamp for a fishing boat

(71) Applicant: Brian McLeroy, Newnan, GA (US)

(72) Inventor: Brian McLeroy, Newnan, GA (US)

(21) Appl. No.: 14/725,280

(22) Filed: May 29, 2015

Related U.S. Application Data
(60) Provisional application No. 62/006,552, filed on Jun. 2, 2014.

(51) Int. Cl. B63B 45/02; F21V 21/22; F21S 8/08

(52) U.S. Cl. CPC B63B 45/02; F21S 8/08; F21V 21/22; F21W 2101/04

(57) ABSTRACT

A stable elevated lamp for a fishing boat provides both elevated and stability in rough water. A rigid pole is mounted to the deck at a strategic location where light is needed, such as near a fishing seat or near the helm console. The pole is provided in telescoping sections, such that it may be easily raised and locked into position, then lowered as desired. The top of the pole features a lantern support mounted within a two-dimensional gimbal in a plane parallel to the water surface. The lantern support is ballasted at the bottom, so as to remain stable as the boat rocks, and accommodates any type of lantern, including battery-powered electric lanterns as well as liquid fuel burning lanterns.

### CROSS-REFERENCE TO RELATED APPLICATIONS

This application claims the benefit of U.S. Provisional Application No. 62/006,552, filed Jun. 2, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to sport fishing equipment and accessories, and in particular to a stable elevated lamp for a fishing boat. Sport fishermen who fish from a boat have discovered the practical utility of having an elevated lamp on the boat for illumination. In addition to enabling the fisherman to see well enough to bait a hook or tie a lure to a fishing line, the lamp attracts plenty of fish to the bait. Unfortunately, even a slight amount of wave action on the water's surface can cause the lamp to swing erratically, which has the opposite effect of frightening the fish away. Also, swaying a liquid-fueled lamp can spill its fuel and introduce the risk of fire, which can be catastrophic on a small boat. A stable elevated lamp for a fishing boat, which provides steady illumination even on choppy water without a fire hazard, would resolve all these problems.

### SUMMARY OF THE INVENTION

Accordingly, the invention is directed to a stable elevated lamp for a fishing boat. The lamp is both elevated and stable in rough water. A rigid pole is mounted to the deck at a strategic location where light is needed, such as near a fishing seat or near the helm console. The pole is provided in telescoping sections, such that it may be easily raised and locked into position, then lowered as desired. The top of the pole features a lantern support mounted within a two-dimensional gimbal in a plane parallel to the water surface. The lantern support is ballasted at the bottom, so as to remain stable as the boat rocks, and accommodates any type of lantern, including battery-powered electric lanterns as well as liquid fuel burning lanterns.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a top perspective view of the first exemplary embodiment mounted behind a fishing seat, displaying the stable elevated lamp 10, the pole 11, the sections 11A, the lantern support 12, the gimbal 13, the lantern 14, and the fishing seat 15.

FIG. 2 is a side view of the first exemplary embodiment mounted behind a fishing seat with the lantern removed, displaying the stable elevated lamp 10, the pole 11, the sections 11A, the lantern support 12, the fishing seat 15, and a horizontal surface 20.

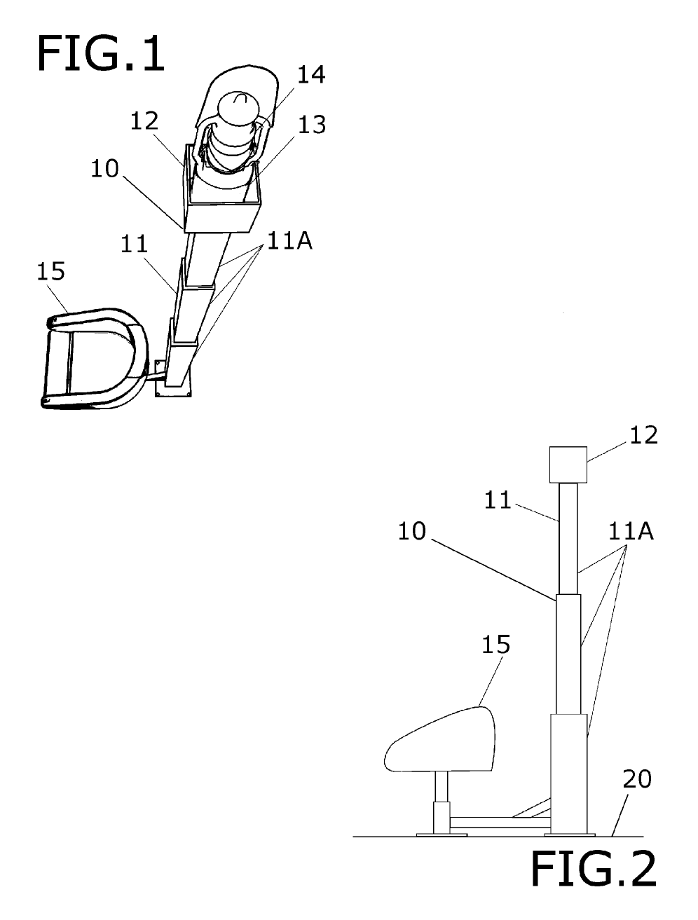

### DETAILED DESCRIPTION OF THE INVENTION

Referring now to the invention in more detail, the invention is directed to a stable elevated lamp 10 for a fishing boat. The lamp 10 is both elevated and stable in rough water. A rigid pole 11 is mounted to a horizontal surface 20. The horizontal surface may be the deck of a boat where the rigid pole is mounted at a strategic location where light is needed, such as near a fishing seat 15 or near the helm console. The pole 11 is provided in telescoping sections 11A, such that it may be easily raised and locked into position, then lowered as desired. The top of the pole 11 features a lantern support 12 mounted within a two-dimensional gimbal 13 in a plane parallel to the water surface. The lantern support 12 is ballasted at the bottom, so as to remain stable as the boat rocks, and accommodates any type of lantern 14, including battery-powered electric lanterns as well as liquid fuel burning lanterns.

It is to be understood that while the present invention is intended for use on a fishing boat, this is not intended as a limiting factor. With suitable modifications, the invention may be used in any location or on any conveyance where stable elevated illumination is desired, despite an unstable platform.

The invention is intended for installation as an after-market modification of a fishing boat by the user, or by a boat repair or customizing shop. Alternate embodiments, intended for installation as original equipment by the manufacturer of the fishing boat, are contemplated.

The first exemplary embodiment provides a pole 11, which may be mounted to a horizontal surface 20 on the deck of a boat or other horizontal surface of a fishing boat. The pole 11 may be mounted behind a fishing seat 15, a helm console, or any other location where the user desires illumination. The pole 11 preferable has a square cross section, but may have a cross section of any other shape, and is provided in a plurality of telescoping sections 11A, preferably three sections 11A. At the upper end of the pole 11, a lantern support 12 is provided. The lantern support 12 is ballasted at the bottom and contains a two-dimensional gimbal 13, similar to the gimbal of a gyrostabilizer. The gimbal 13 will rotate freely in two dimensions, in response to wave action and the sway of the boat. The lantern support 12 contains three mounting screws distributed at 120° angles around the gimbal 13, which may be tightened or loosened by hand to secure a lantern 14 provided by the user.

To use the first exemplary embodiment, the user secures a lantern 14 into the gimbal 13, using the mounting screws which are provided, and activates the lantern 14. The user then extends the telescoping sections 11A of the pole 11 and locks them into position.

The pole 11, the lantern support 12, the gimbal 13, and the mounting screws are preferably manufactured from a rigid, durable material, such as aluminum alloy or steel. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A stable elevated lamp, comprising:
(a) a lantern;
(b) a rigid pole;
(c) said rigid pole having a lower end and an upper end;
(d) a horizontal surface;
(e) said lower end being mounted to said horizontal surface;
(f) a lantern support;
(g) said lantern support having a bottom;
(h) said lantern support being affixed to said rigid pole at said upper end;
(i) said lantern support having a ballast attached to said bottom;
(j) a gimbal;
(k) said gimbal being mounted within said lantern support;
(l) a plurality of mounting screws;
(m) said plurality of mounting screws being screwed through said gimbal such that said plurality of mounting screws is evenly distributed around said gimbal; and
(n) said mounting screws being adjustable.

2. The stable elevated lamp of claim 1, wherein said rigid pole has a square cross-section.

3. The stable elevated lamp of claim 2, wherein said rigid pole further comprises a plurality of telescoping sections.

5. The stable elevated lamp of claim 1, wherein said rigid pole has a circular cross-section.

6. The stable elevated lamp of claim 5, wherein said rigid pole further comprises a plurality of telescoping sections.

8. The stable elevated lamp of claim 1, wherein said horizontal surface is a deck of a boat.

9. The stable elevated lamp of claim 1, wherein said rigid pole is mounted behind a fishing seat.
